(19) United States
(12) Patent Application Publication
(10) Pub. No.: US 2015/0235392 A1
(43) Pub. Date: Aug. 20, 2015

(54) DRAWING DATA GENERATION DEVICE AND IMAGE DRAWING DEVICE

(71) Applicants: Satoshi Sakurai, Tokyo (JP); Shoichiro Kuboyama, Tokyo (JP)

(72) Inventors: Satoshi Sakurai, Tokyo (JP); Shoichiro Kuboyama, Tokyo (JP)

(73) Assignee: Mitsubishi Electric Corporation, Tokyo (JP)

(21) Appl. No.: 14/360,790

(22) PCT Filed: Jan. 27, 2012
(86) PCT No.: PCT/JP12/00531

§ 371 Date: May 27, 2014

(51) Int. Cl. G06T 11/20; G06T 15/04; G06T 17/20; G06T 11/00

(52) U.S. Cl. CPC G06T 11/203; G06T 11/001; G06T 15/04; G06T 17/20

(57) ABSTRACT

A node acquisition unit 11 receives as its input, polygon groups which have a plurality of levels of detail represented in a tree structure and render a model at the plurality of levels of detail, and texture image groups properly assigned to the polygon groups, respectively, and determines nodes corresponding to the texture image groups to be merged. A texture atlas generating unit 12 generates a texture atlas group by merging the texture image groups using information about the nodes the node acquisition unit 11 generates, and converts the texture coordinates of the vertices of the polygon groups while relating the texture coordinates to a drawing position.

### TECHNICAL FIELD

The present invention relates to a drawing data generation device and image drawing device that render a two-dimensional or three-dimensional shape using polygon groups which are managed in a tree structure and render a model at a plurality of levels of detail.

### BACKGROUND ART

As a method of rendering a two-dimensional or three-dimensional shape in computer graphics, a polygon model has been widely used. The polygon model renders a shape by merging triangles which are mainly used as a unit shape.

To improve the rendering power of the polygon model, texture mapping is widely used which assigns a two-dimensional texture image to the surface of a polygon, followed by mapping and drawing. Generally, a drawing flow using the texture mapping issues a command to select a texture image to be used to a polygon drawing device like a GPU, and then issues a polygon drawing command. Since the selection command takes an especially long processing time, a texture atlas has been generally used which merges a plurality of texture images to a single image in advance as shown in FIG. 1 to reduce the drawing time. FIG. 1(a) shows polygon group drawing without using a texture atlas, and FIG. 1 (b) shows polygon group drawing using a texture atlas.

Using the texture atlas enables reducing the number of commands issued in the drawing processing as shown in FIG. 2, in which FIG. 2 (a) shows a drawing flow of FIG. 1(a) and FIG. 2 (b) shows a drawing flow of FIG. 1(b). Here, since the image size used as texture images has an upper limit for each polygon drawing device, if there are a large number of texture images, they cannot be put into a single texture atlas, and a plurality of texture atlases are generated.

On the other hand, since the drawing time of a polygon model depends on the number of polygons to be drawn, a model comprising a lot of polygons will take a long time. In such a case, to reduce the drawing time, an LOD (Level Of Detail) technique is generally used as shown in patent documents 1 and 2, for example. The LOD technique is a technique for reducing the number of polygons to be drawn by reconstructing part of a model with a smaller number of polygons in accordance with the relationships between viewpoint and the position of the model or by properly using models with different levels of detail prepared in advance. In the LOD using models with different levels of detail, model groups are often managed in a tree structure. For example, a non-patent document 1 discloses a technique that assigns a node of the tree structure to a single polygon model, and assigns a simplified model formed by merging child nodes to a parent node to manage them. FIG. 3 shows an example of a tree structure, and polygon groups and texture image groups corresponding to the individual nodes. Here, FIG. 3(a) shows a tree structure showing relationships between the polygon groups; FIG. 3(b) shows the polygon groups corresponding to the individual nodes; and FIG. 3(c) shows textures corresponding to the individual nodes. In addition, the LOD technique carries out drawing by appropriately selecting the nodes so as not to draw the same model with different levels of detail at the same time. FIG. 4(a) shows a resultant example of selecting the target nodes to be drawn from the tree structure of FIG. 3, and FIG. 4(b) shows a result of drawing the polygon groups corresponding to the nodes selected.

Here, when generating a texture atlas by merging the texture images used in the LOD described above, if the number of the nodes of the tree structure is large, it is necessary to generate a plurality of texture atlases. In this case, since the target nodes to be drawn in the tree structure is only part of all the nodes, to carry out high speed drawing, it is necessary to appropriately generate the texture atlases in such a manner as to reduce the number of times of issuing a texture image designating command at the drawing, and to draw.

### PRIOR ART DOCUMENT

### Patent Document

Patent Document 1: Japanese Patent Laid-Open No. 8-293041/1996.
Patent Document 2: Japanese Patent Laid-Open No. 10-172003/1998.

### NON-PATENT DOCUMENT

Non-Patent Document 1: R. Chang, T. Butkiewicz, N. Pollard, C. Ziemkiewicz, W. Ribarsky, and Z. Wartell, “Legible Simplification of Textured Urban Models”, IEEE Computer Graphics and Applications, 2008.

### DISCLOSURE OF THE INVENTION

### Problems to be Solved by the Invention

However, a method has not been proposed conventionally which carries out drawing by generating texture atlases by selecting combinations of the texture images from the texture image groups related to the nodes of the tree structure in such a manner as to reduce the texture image selection commands used at the drawing, and to implement such a method has been desired.

The present invention is implemented to solve the foregoing problem. Therefore it is an object of the present invention to provide a drawing data generation device and an image drawing device capable of generating texture atlases in such a manner as to reduce the texture image selection commands used at the drawing.

### Means for Solving the Problem

A drawing data generation device in accordance with the present invention comprises: a node acquisition unit that receives as its input, polygon groups which have a plurality of levels of detail represented in a tree structure and render a model at the plurality of levels of detail, and texture image groups properly assigned to the polygon groups, respectively, and that determines nodes corresponding to the texture image groups to be merged; and a texture atlas generating unit that generates a texture atlas group by merging the texture image groups using information about the nodes the node acquisition unit generates, and that converts texture coordinates of vertices of the polygon groups while relating the texture coordinates to a drawing position.

### Advantages of the Invention

The drawing data generation device in accordance with the present invention is configured in such a manner as to determine the nodes corresponding to the texture image groups to be merged, and to generate the texture atlas groups by merging the texture image groups using the information about the nodes. Accordingly, it can generate the texture atlas in such a manner as to reduce the texture image selection commands used at the drawing.

### BRIEF DESCRIPTION OF THE DRAWINGS

FIG. 1 is a diagram illustrating a polygon group drawing when not using a texture atlas and when using it;

FIG. 2 is a diagram illustrating drawing flows corresponding to FIG. 1;

FIG. 3 is a diagram illustrating an example of a tree structure, polygon groups corresponding to individual nodes, and texture image groups;

FIG. 4 is a diagram illustrating target nodes to be drawn and a drawing result;

FIG. 5 is a block diagram showing a configuration of an image drawing device of an embodiment 1 in accordance with the present invention;

FIG. 6 is a flowchart showing the operation of a node acquisition unit of the image drawing device of the embodiment 1 in accordance with the present invention;

FIG. 7 is a diagram illustrating node sets (Part 1) in the image drawing device of the embodiment 1 in accordance with the present invention;

FIG. 8 is a diagram illustrating node sets (Part 2) in the image drawing device of the embodiment 1 in accordance with the present invention;

FIG. 9 is a diagram illustrating node sets (Part 3) in the image drawing device of the embodiment 1 in accordance with the present invention;

FIG. 10 is a diagram illustrating node sets (Part 4) in the image drawing device of the embodiment 1 in accordance with the present invention;

FIG. 11 is a diagram illustrating node sets (Part 5) in the image drawing device of the embodiment 1 in accordance with the present invention;

FIG. 12 is a diagram illustrating node sets (Part 6) in the image drawing device of the embodiment 1 in accordance with the present invention;

FIG. 13 is a diagram illustrating node sets (Part 7) in the image drawing device of the embodiment 1 in accordance with the present invention;

FIG. 14 is a diagram illustrating node sets (Part 8) in the image drawing device of the embodiment 1 in accordance with the present invention;

FIG. 15 is a diagram illustrating a resultant example when applying the processing of the node acquisition unit to the nodes at all the depths in the image drawing device of the embodiment 1 in accordance with the present invention;

FIG. 16 is a diagram illustrating the operation of the texture atlas generating unit in the image drawing device of the embodiment 1 in accordance with the present invention;

FIG. 17 is a diagram illustrating a range of texture coordinates before and after generating the texture atlas in the image drawing device of the embodiment 1 in accordance with the present invention;

FIG. 18 is a diagram illustrating a state at which drawing target nodes are decided in the image drawing device of the embodiment 1 in accordance with the present invention;

FIG. 19 is a diagram illustrating a drawing target list of each set in the image drawing device of the embodiment 1 in accordance with the present invention; and

FIG. 20 is a flowchart showing the operation of a drawing unit of the image drawing device of the embodiment 1 in accordance with the present invention.

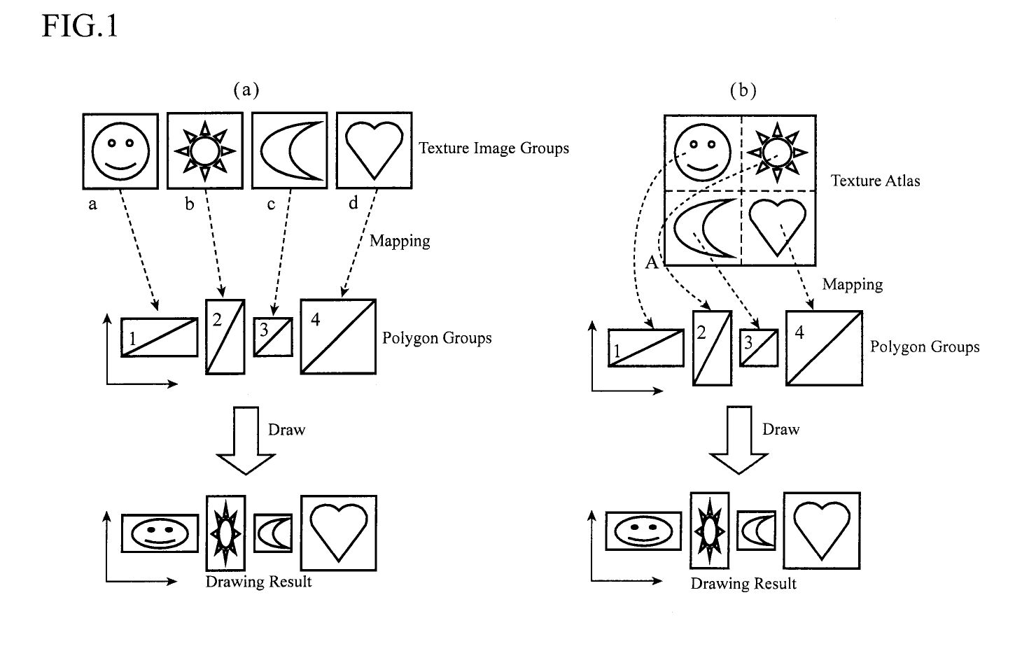

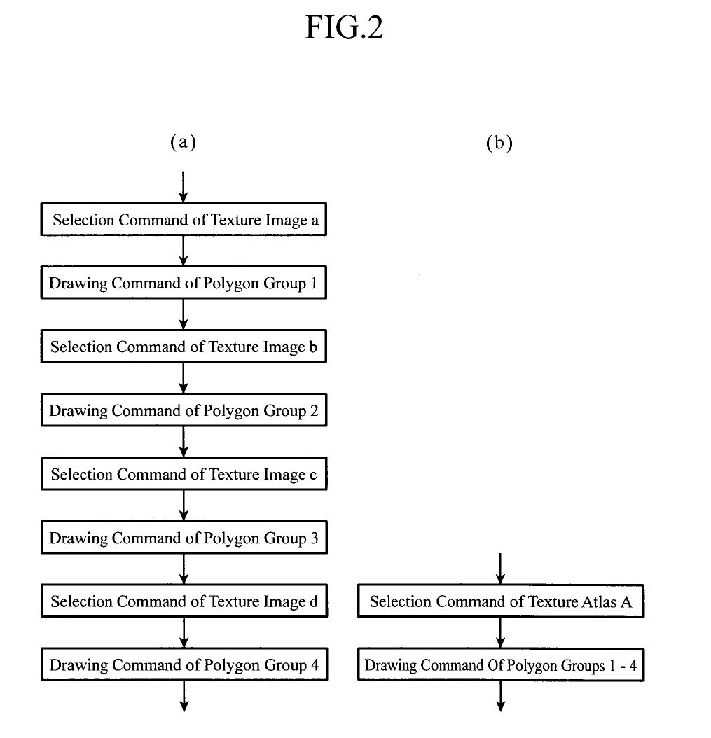

### BEST MODE FOR CARRYING OUT THE INVENTION

According to the present invention, it manages polygon groups with a plurality of levels of detail having proper texture images in a tree structure, and generates, when child nodes in the tree structure which are merged and simplified correspond to a parent node, a texture atlas from the texture image groups so as to enable carrying out drawing with a smaller number of texture image designating commands, followed by appropriately selecting the polygon groups to be drawn and carrying out drawing by mapping the texture atlas.

The best mode for carrying out the invention will now be described with reference to the accompanying drawings to explain the present invention in more detail.

### Embodiment 1

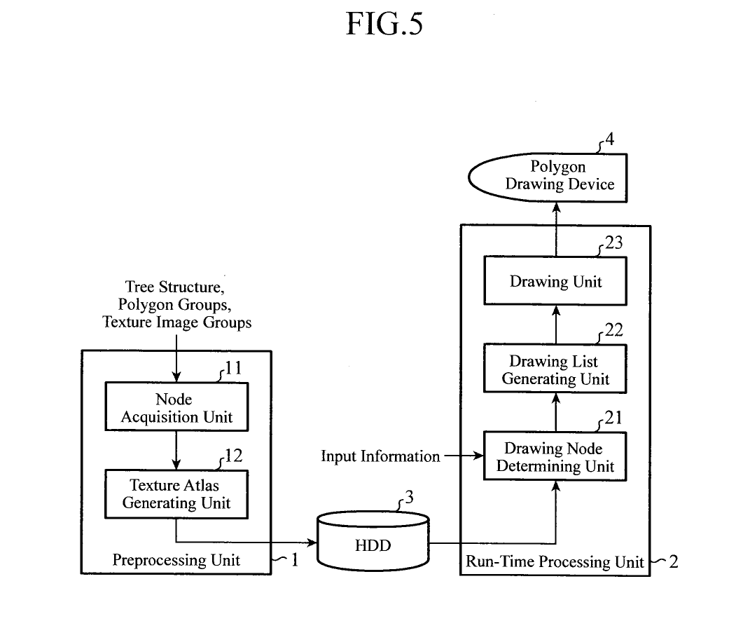

FIG. 5 is a block diagram showing a configuration of an image drawing device of the embodiment 1.

As shown in FIG. 5, the image drawing device comprises a preprocessing unit 1, a run-time processing unit 2, an HDD (hard disk drive) 3, and a polygon drawing device 4. The preprocessing unit 1, which constitutes a drawing data generation device, generates a tree structure, polygon groups, and a texture atlas group from a tree structure, polygon groups, and texture image groups, and comprises a node acquisition unit 11 and a texture atlas generating unit 12. The run-time processing unit 2, which issues a drawing command to the polygon drawing device 4 in accordance with the tree structure, polygon groups and texture atlas group the preprocessing unit 1 generates, comprises a drawing node determining unit 21, a drawing list generating unit 22 and a drawing unit 23. The HDD 3 is a storage that stores a generation result of the preprocessing unit 1. The polygon drawing device 4, which consists of a GPU or the like, is a device that carries out drawing in accordance with a drawing command from the run-time processing unit 2.

The node acquisition unit 11 of the preprocessing unit 1 is a processing unit that receives polygon groups which have a plurality of levels of detail represented in a tree structure and which render a model in the plurality of levels of detail, and texture image groups properly assigned to the polygon groups, respectively, and that determines nodes corresponding to the texture image groups to be merged. The texture atlas generating unit 12 is a processing unit that generates a texture atlas group by merging the texture image groups using information about the nodes the node acquisition unit 11 generates, and that converts the texture coordinates of vertices of the polygon groups while relating the texture coordinates to the drawing position.

The drawing node determining unit 21 in the run-time processing unit 2 is a processing unit that using the tree structure, polygon groups and texture atlas groups the texture atlas generating unit 12 outputs, decides the polygon groups to become a drawing target using at least information about a viewpoint position. The drawing list generating unit 22 is a processing unit that generates a list showing drawing order of the drawing target polygon groups the drawing node determining unit 21 decides. The drawing unit 23 is a processing unit that issues to the polygon drawing device 4 a command of drawing the drawing target polygon groups using the list the drawing list generating unit 22 generates.

Next, the operation of the image drawing device of the embodiment 1 will be described.

In FIG. 5, the preprocessing unit 1 receives as its input the plurality of polygon groups, the texture image groups corresponding to them, and the tree structure representing the relationships between the polygon groups, generates a small number of the texture atlases from the texture image groups, appropriately converts the texture coordinates of the vertices of the polygon groups, and supplies the tree structure, the polygon groups, and the texture atlases to the HDD 3. The run-time processing unit 2 reads from the HDD 3 the tree structure, texture atlas groups, and polygon groups the preprocessing unit 1 outputs, determines the polygon groups to become the drawing target in accordance with the input information such as the viewpoint position, and issues the command to draw them to the polygon drawing device 4.

Next, the operation of the node acquisition unit 11 will be described.

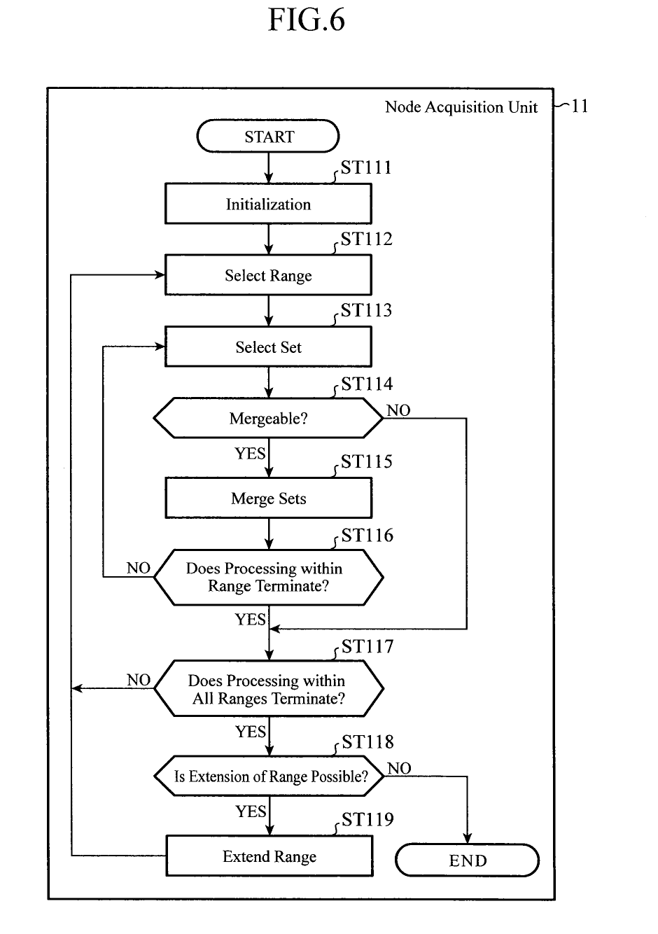

FIG. 6 is a flowchart showing the operation of the node acquisition unit 11. The node acquisition unit 11, referring to the input tree structure and texture image groups, applies the following processing to the individual node groups at the same depth in the tree structure.

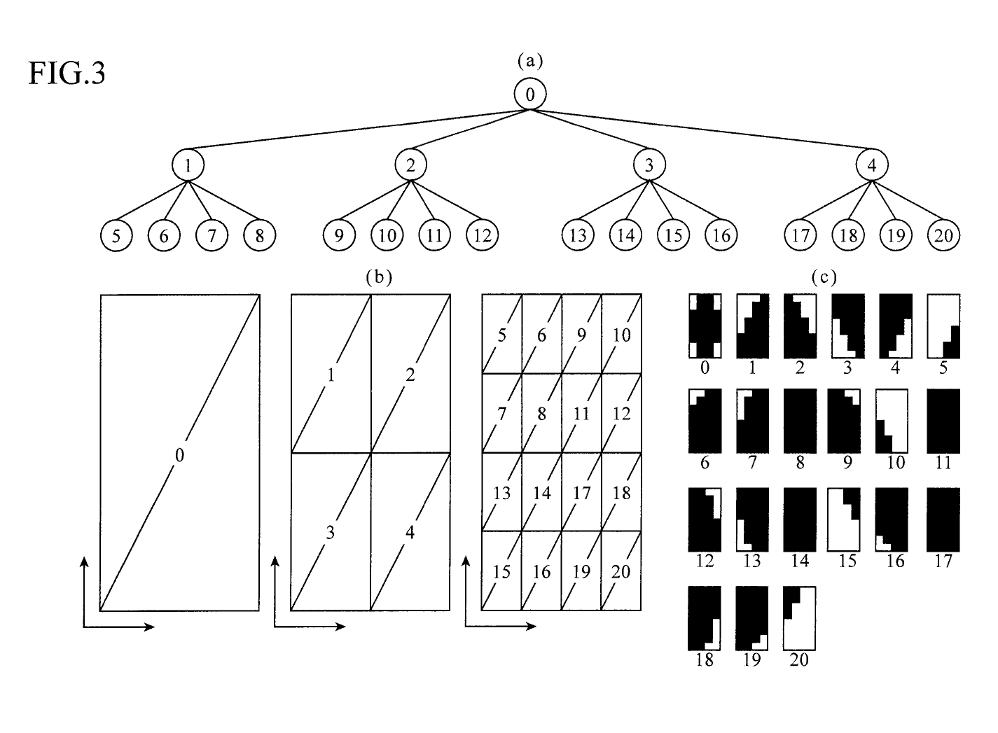

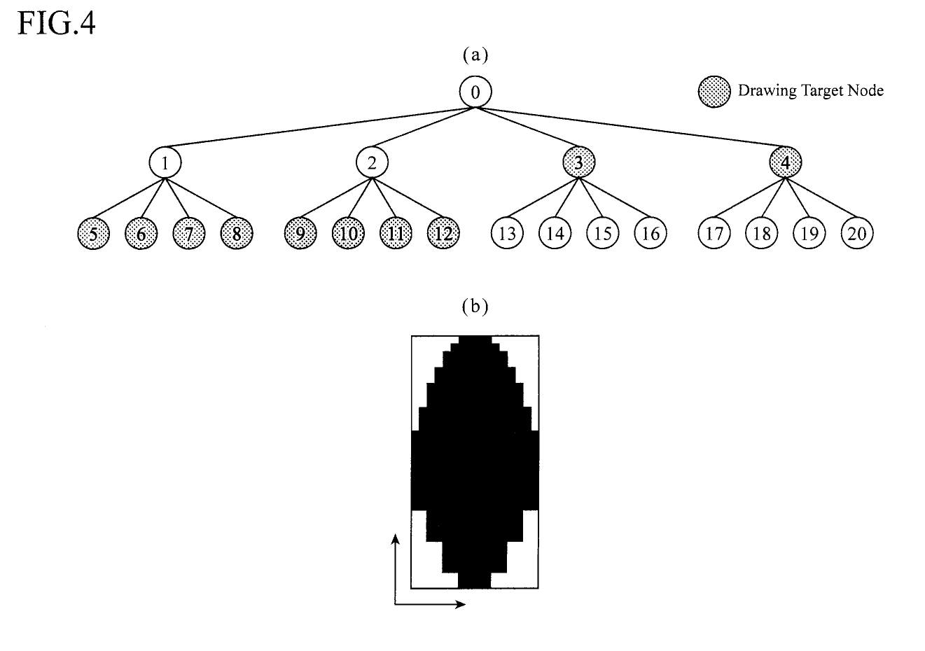

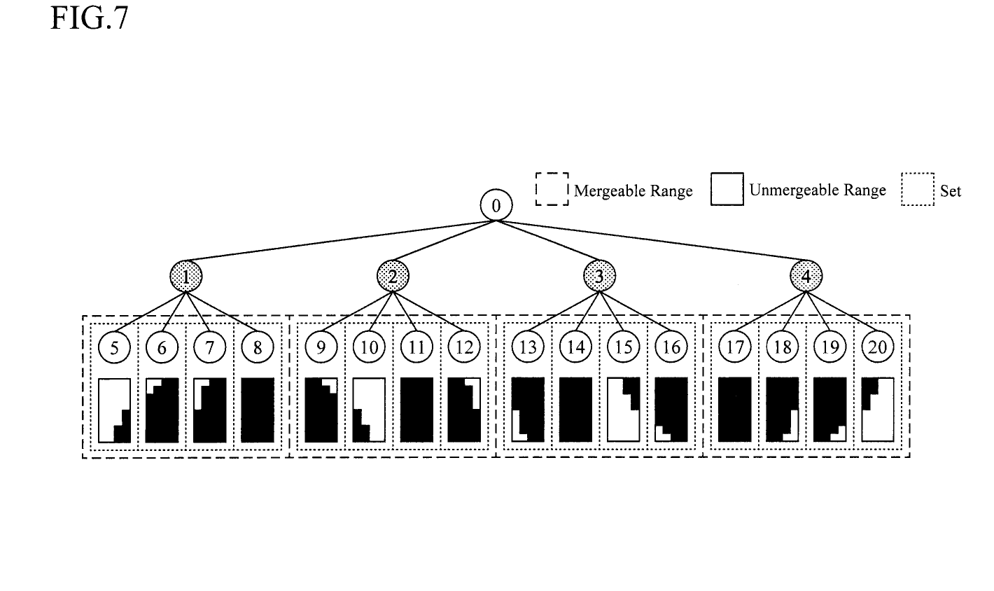

First, as the initialization processing, the node acquisition unit 11 makes each node at the same depth a single set. In addition, it decides that all the nodes at the depth 1-step closer to the root than the depth of the processing target are ancestor nodes. Then it decides that the nodes which are at the depth of the processing target and have the same ancestor node are mergeable range (step ST111). FIG. 7 shows a result that the node acquisition unit 11 receives the tree structure and texture image groups shown in FIG. 3 as the input, and applies step ST111 on the assumption that the node groups at the leaf depth are the processing target. Incidentally, in FIG. 7 to FIG. 15, a dotted line frame denotes a set, a broken line frame denotes mergeable range, and a solid line frame denotes unmergeable range.

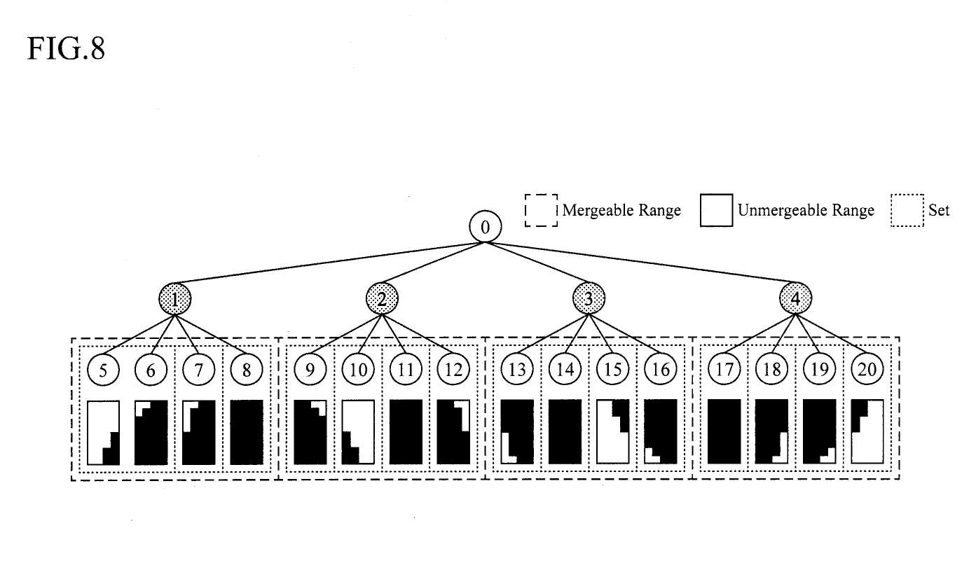

Next, the node acquisition unit 11 selects one of the mergeable range (step ST112). Then from among the sets within the selected range, it selects two sets with the minimum gross area of the texture images corresponding to the nodes within the sets (step ST113), and decides on whether the sets are mergeable or not (step ST114). Here, the term “mergeable” means that when the node acquisition unit 11 merges all the texture image groups within the two sets selected to make a single image, the merged result comes within the texture size the hardware can use. Incidentally, whether the merged result comes within the texture size or not can be decided by solving a two-dimensional bin packing problem which packs the individual texture images into a rectangle with the texture size. When unmergeable, the node acquisition unit 11 decides the range as the unmergeable range and proceeds to step ST117. In contrast, when mergeable, the node acquisition unit 11 merges the two sets selected (step ST115), and decides on whether two or more sets remain within the range (step ST116). FIG. 8 shows a result that the left-end range is selected in the state of FIG. 7 and the two sets are merged.

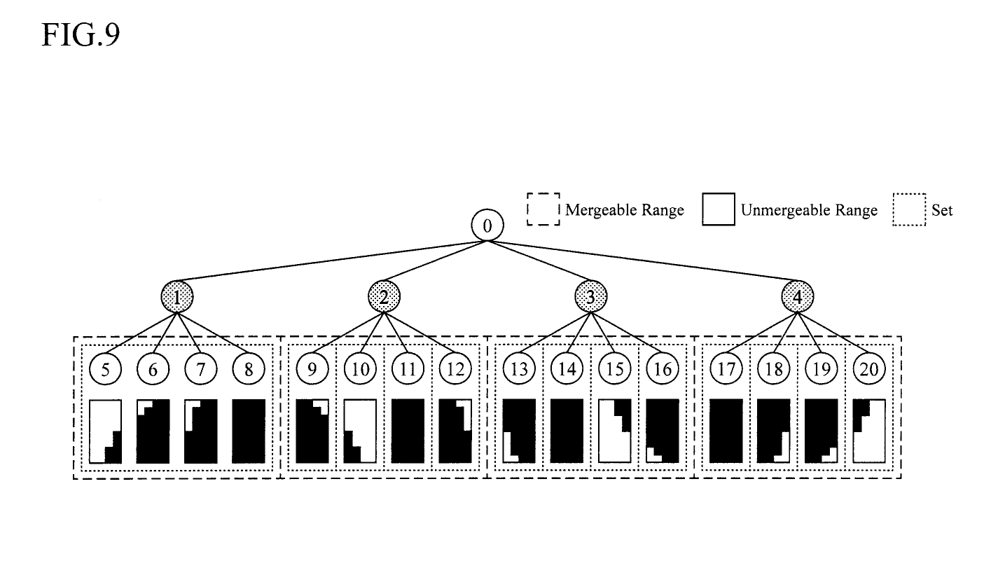

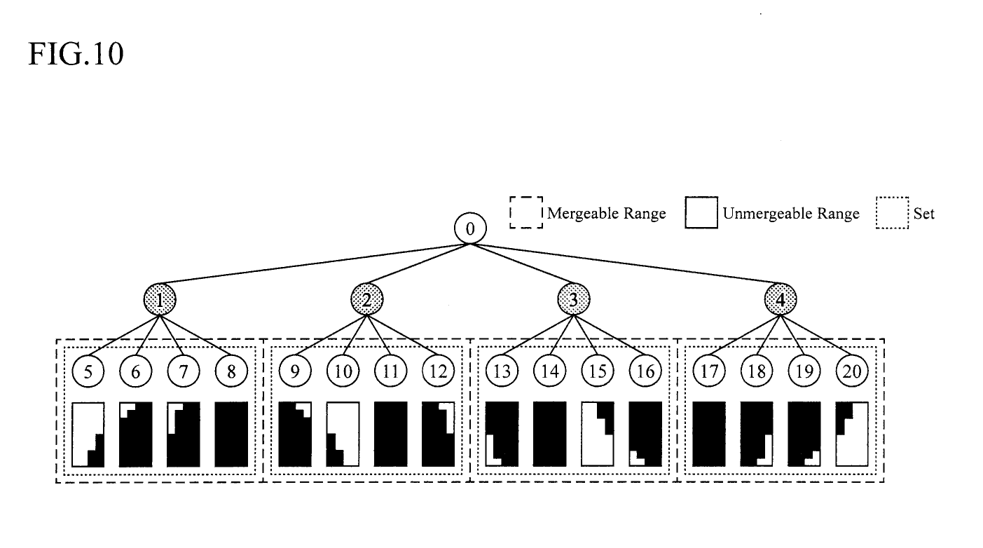

If two or more sets are left within the range, the node acquisition unit 11 returns to step ST113 to repeat the same processing. FIG. 9 shows a state in which the node acquisition unit 11 merges all the sets within the left-end range into a single set. If only a single set is left within the range, the node acquisition unit 11 decides on whether all the mergeable ranges are selected at step ST112 (step ST117). If there are any range unselected, the node acquisition unit 11 returns to step ST112 to repeat the same processing after selecting the unselected range. FIG. 10 shows a state in which all the mergeable ranges are selected at step ST112 to undergo the processing, and all the nodes within each range are merged into a single set. If all the ranges have already been selected at step ST112 and the merging processing of the sets has been applied at step ST117, the node acquisition unit 11 decides on wither two or more mergeable ranges are left, and if the only one or less mergeable range is left, it terminates the processing (step ST118). Otherwise, it brings the depth of the ancestor node 1-step closer to the root, merges the mergeable ranges having the same ancestor node (step ST118), and returns to step ST112.

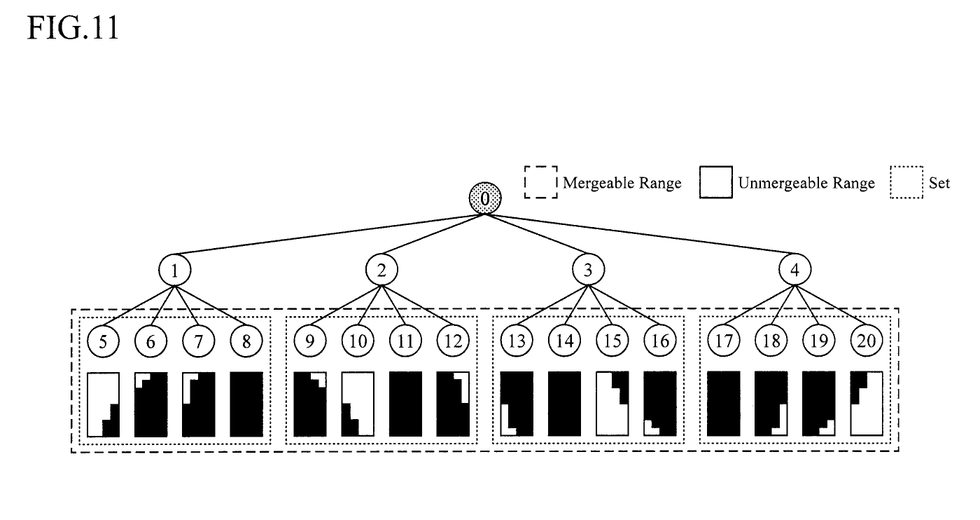

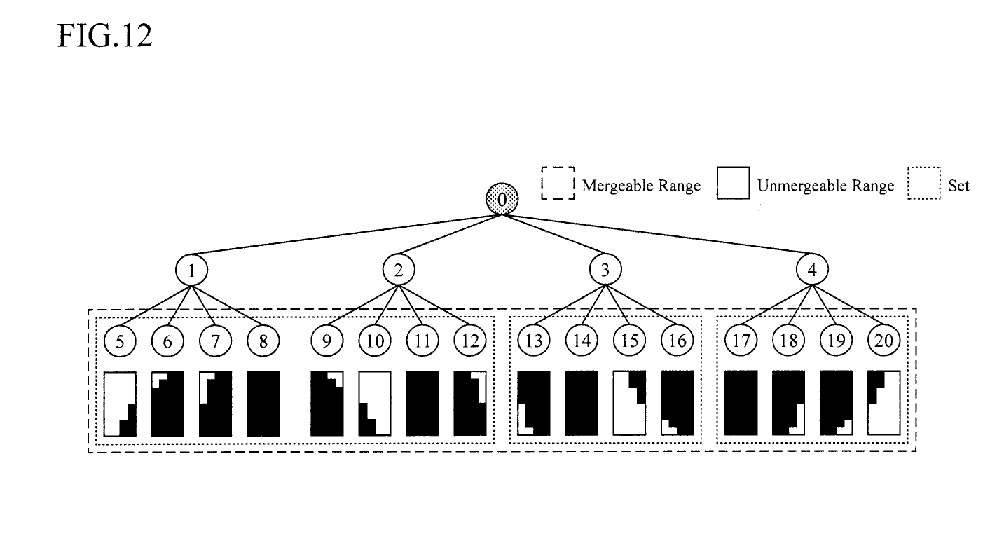

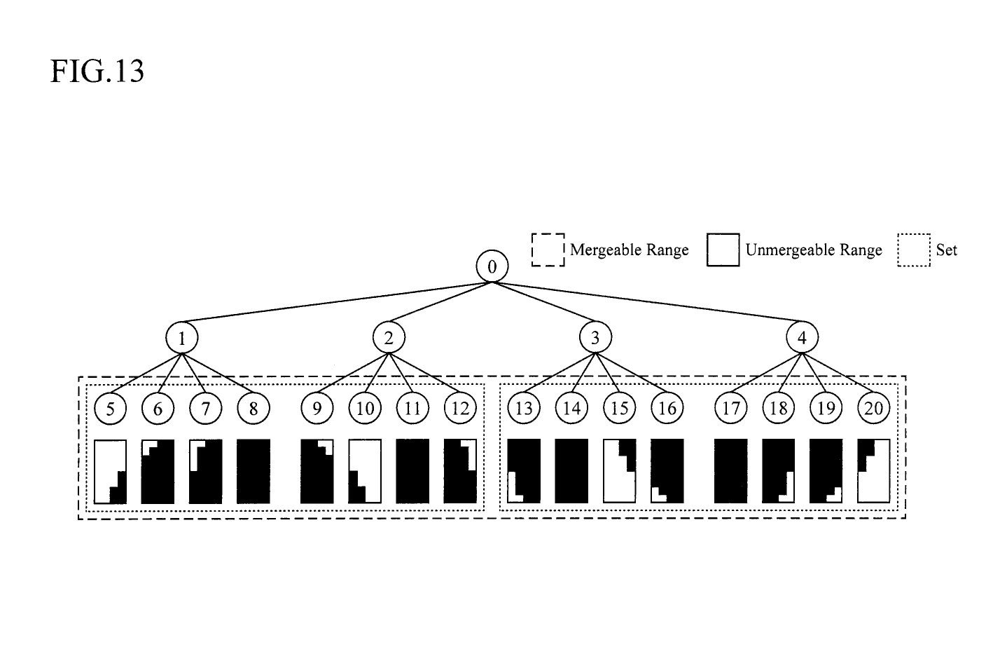

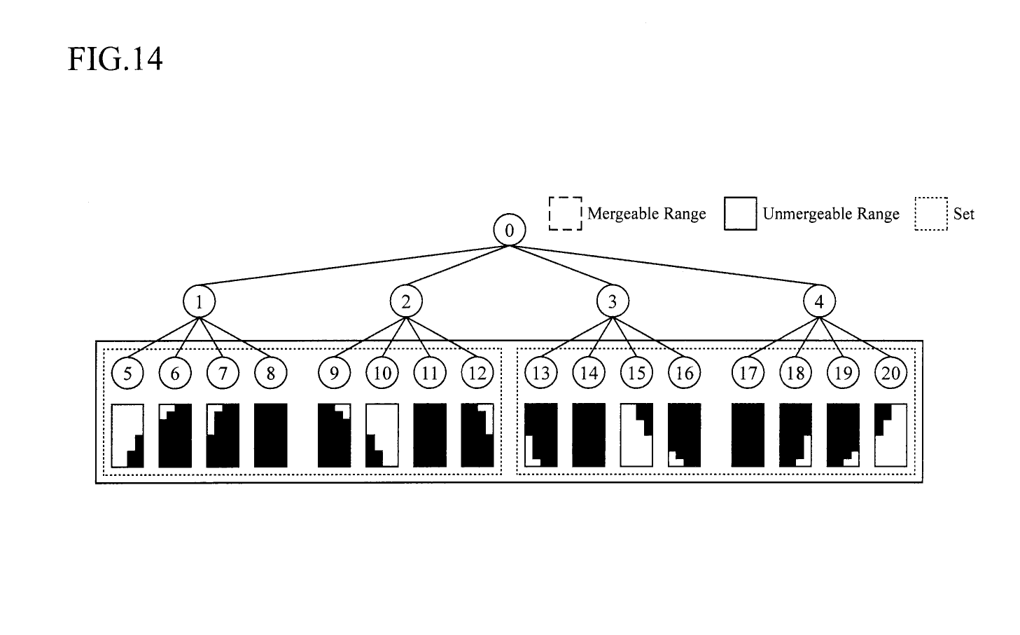

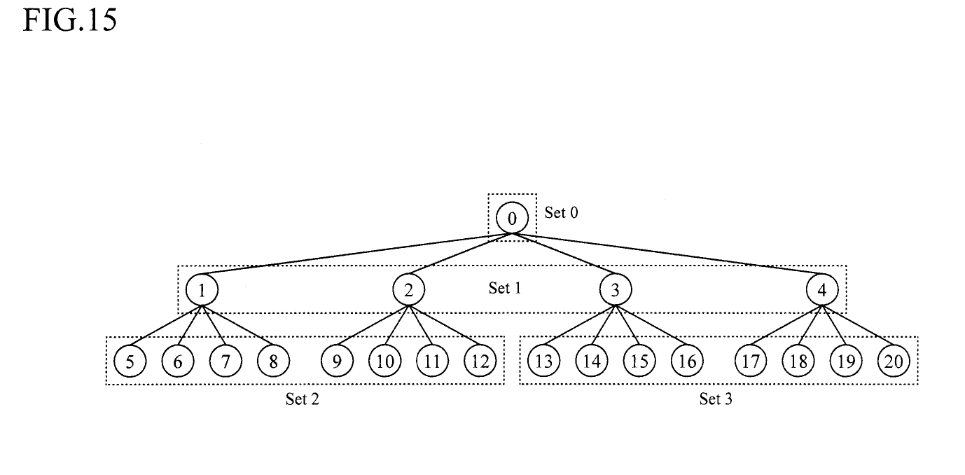

FIG. 11 shows a resultant state in which the node acquisition unit 11 brings the ancestor node 1-step closer to the root from the state of FIG. 10, and merges mergeable ranges with the same ancestor nodes. FIG. 12 and FIG. 13 show further state transition during the processing. In addition, FIG. 14 shows a node state at the time when the node acquisition unit 11 terminates its processing. Incidentally, FIG. 14 shows the result that after making a decision that the set including the nodes 5 to 12 cannot be merged with the set including nodes 13 to 20 at step ST114, the node acquisition unit 11 terminates its processing. Finally, the node acquisition unit 11 outputs the generated sets along with the input tree structure, texture groups, and texture image groups. FIG. 15 shows a resultant example when applying the processing of the node acquisition unit 11 to the nodes at all the depth. In FIG. 15, unique IDs 0-3 are assigned to all the sets for the sake of the following description.

More specifically, the node acquisition unit 11 gathers the nodes at the same depth in the tree structure beginning from a nearer relative, and generates a node set that represents the set of the texture image groups capable of generating a texture atlas with the size closest to the maximum size the polygon drawing device can use.

Next, the operation of the texture atlas generating unit 12 will be described with reference to FIG. 16.

The texture atlas generating unit 12 merges the texture images corresponding to the nodes within the sets the node acquisition unit 11 generates, and makes each of them a single texture atlas. Incidentally, although a generating method of the texture atlas is optional, it can be implemented by solving the two-dimensional bin packing problem as in the processing at step ST114 of the node acquisition unit 11, for example. FIG. 16 shows a result of generating the texture atlases corresponding to the individual sets of FIG. 15. In addition, the texture atlas generating unit 12 appropriately updates the texture coordinates of the vertices of each polygon.

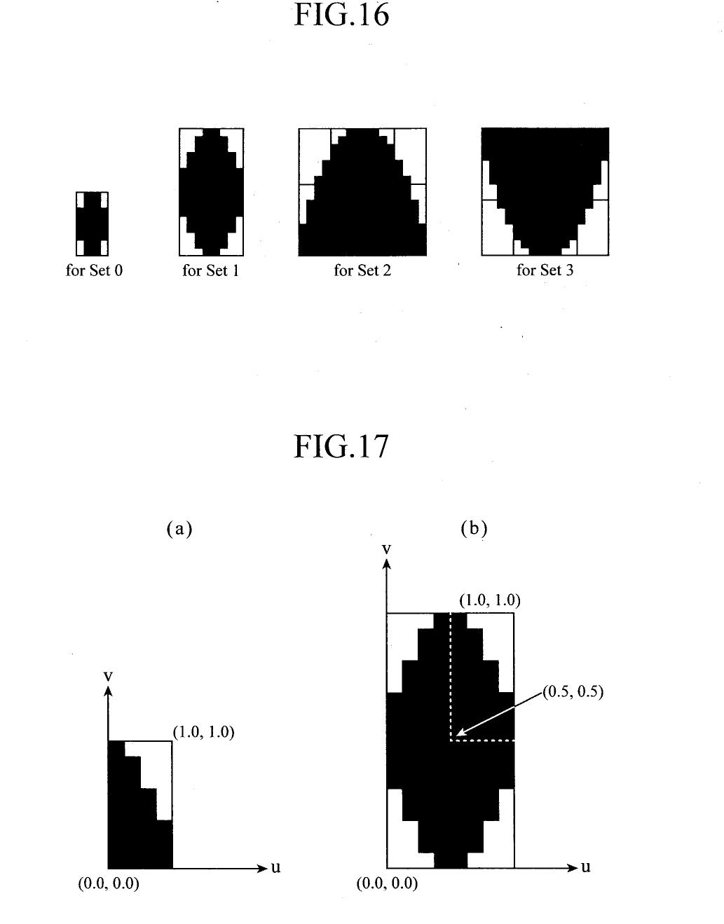

For example, FIG. 17(a) shows the range of the texture coordinates before the texture atlas generation, and FIG. 17(b) shows the range of texture coordinates after the texture atlas generation. More specifically, FIG. 17(a) shows the texture image to be mapped on the polygon group 2 of FIG. 3, in which the texture coordinates of the range from (0.0, 0.0) to (1.0, 1.0) are assigned to the corresponding vertices of the polygon. On the other hand, after the texture atlas generation, since the texture image occupies the range from (0.5, 0.5) to (1.0, 1.0) as shown in FIG. 17 (b), the following conversion is applied to the texture coordinates of the individual vertices.

U′=0.5+0.5*U (1)

V′=0.5+0.5*V (2)

where (U, V) is the texture coordinates of a vertex before the conversion and (U′, V′) is the texture coordinates of the vertex after the conversion. Finally, the texture atlas generating unit 12 writes the input tree structure, the polygon groups with the texture coordinates of their vertices being updated, and the generated texture atlases on the HDD 3.

Next, the operation of the drawing node determining unit 21 in the run-time processing unit 2 will be described.

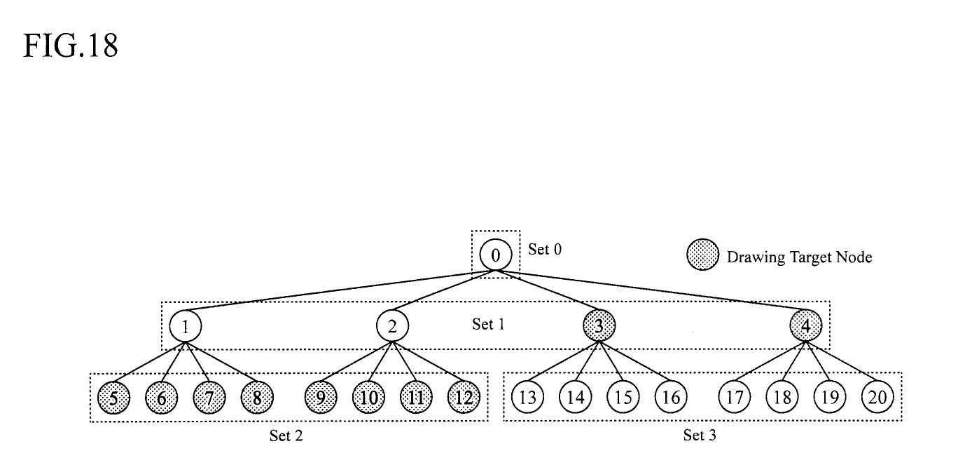

The drawing node determining unit 21 reads from the HDD 3 the tree structure, texture atlases and polygon groups the preprocessing unit 1 has recorded, and determines the polygon groups to be used as the drawing target from the input information such as the viewpoint position. In this case, it determines in such a manner as not to designate the same model with different levels of detail as the drawing target at the same time. Although the method of determining the drawing target is optional, the drawing node determining unit 21 can set a threshold for each node of the tree structure in advance, and determine the drawing target in accordance with relationships between the distance from the viewpoint and the threshold, for example. First, the drawing node determining unit 21 sets the root node as a temporary drawing target node, and if the distance between the viewpoint and the polygon group corresponding to the root node is not less than the threshold, it determines the polygon group corresponding to the root node as the drawing target. In contrast, if the distance is less than the threshold, it removes the root node from the drawing target, and determines a child of the root node as the temporary drawing target node. Then repeating the same decision on the temporary drawing target node makes it possible to determine the drawing target. FIG. 18 shows an example that determines the drawing target nodes for the tree structure of FIG. 3. In FIG. 18, shaded numbers designate the drawing target nodes.

Next, the operation of the drawing list generating unit 22 will be described.

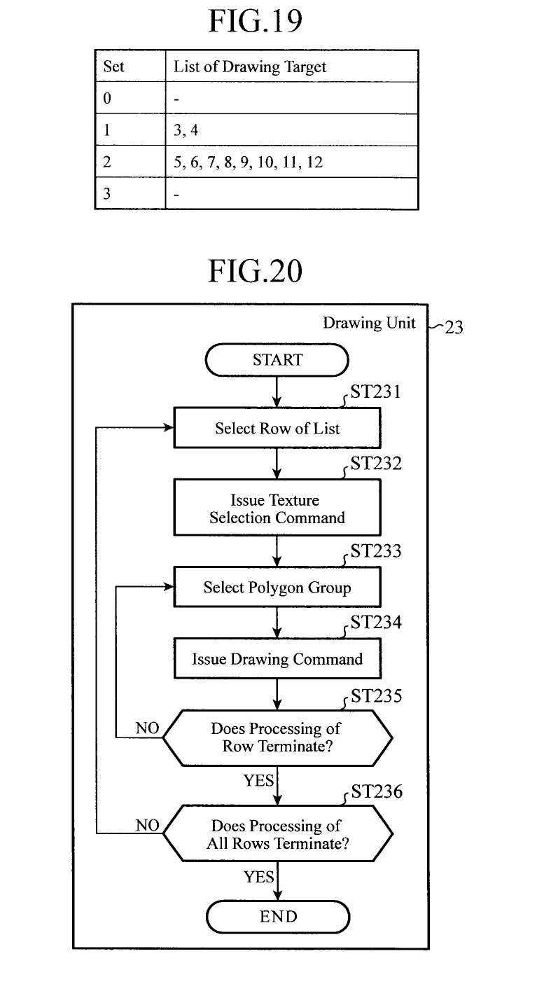

The drawing list generating unit 22 generates a list by gathering the IDs of the drawing target nodes for each set. FIG. 19 shows an example of a list generated from the tree structure shown in FIG. 18. More specifically, in the set 1, the drawing target nodes 3 and 4 are mentioned in the drawing target list, and in the set 2, the drawing target nodes 5, 6, 7, 8, 9, 10, 11 and 12 are mentioned.

Next, the operation of the drawing unit 23 will be described with reference to the flowchart of FIG. 20.

The drawing unit 23 selects a nonempty row in the list generated by the drawing list generating unit 22 (step ST231), and sends a command to select the texture atlas corresponding to the row selected to the polygon drawing device 4 (step ST232). Next, the drawing unit 23 selects the polygon groups corresponding to the IDs of the nodes included in the row selected (step ST233), and sends a command to draw the selected polygon groups to the polygon drawing device 4 (step ST234). Then it decides on whether step ST233 and step ST234 are applied to all the node IDs in the row (step ST235), and unless they are applied, it returns to step ST233. If they have already been applied, it decides on whether step ST231 to step ST235 have been applied to all the rows of the list or not (step ST236), and unless they have already been applied, it returns to step ST231. Incidentally, the drawing processing of a polygon in the polygon drawing device 4 is the same as a common polygon drawing method, the description thereof will be omitted.

As described above, according to the drawing data generation device of the embodiment 1, it comprises the node acquisition unit that receives as its input the polygon groups which have the plurality of levels of detail represented in the tree structure and render a model in the plurality of levels of detail and the texture image groups properly assigned to the polygon groups, respectively, and that determines the nodes corresponding to the texture image groups to be merged; and the texture atlas generating unit that merges the texture image groups using information about the nodes the node acquisition unit generates to generate the texture atlas groups, and that converts the texture coordinates of the vertices of the polygon groups while relating the texture coordinates to the drawing position. Accordingly, it can generate the texture atlases in such a manner as to reduce the texture image selection commands used at the drawing.

In addition, according to the drawing data generation device of the embodiment 1, the node acquisition unit gathers the nodes at the same depth in the tree structure beginning from a nearer relative, and generates a node set that represents the set of the texture image groups capable of generating a texture atlas with the size closest to the maximum size the polygon drawing device that carries out the polygon drawing can use. Accordingly, it can minimize the texture image selection commands used at the drawing, thereby being able to carry out high speed drawing.

In addition, according to the image drawing device of the embodiment 1, it comprises the node acquisition unit that receives as its input the polygon groups which have the plurality of levels of detail represented in the tree structure and render a model in the plurality of levels of detail and the texture image groups properly assigned to the polygon groups, respectively, and that determines the nodes corresponding to the texture image groups to be merged; the texture atlas generating unit that merges the texture image groups using information about the nodes the node acquisition unit generates so as to generate the texture atlas groups, and that converts the texture coordinates of the vertices of the polygon groups while relating the texture coordinates to the drawing position; the drawing node determining unit that determines the drawing target polygon groups using the information at least about the viewpoint position by using the tree structure, polygon groups, and texture atlas groups the texture atlas generating unit outputs; the drawing list generating unit that generates the list indicating the drawing order as to the drawing target polygon groups the drawing node determining unit determines; and the drawing unit that issues to the polygon drawing device the commands to draw the drawing target polygon groups using the list the drawing list generating unit generates. Accordingly, it can generate the texture atlases by selecting the combinations of the texture images in such a manner as to reduce the texture image selection commands used at the drawing, thereby being able to carry out high speed drawing.

In addition, according to the image drawing device of the embodiment 1, the drawing node determining unit determines the target nodes to be drawn in such a manner as not to select the same polygon group rendered at different levels of detail in accordance with the thresholds set for the individual nodes of the tree structure and the positional relationships with the viewpoint. Accordingly, it can reduce the drawing time.

In addition, according to the image drawing device of the embodiment 1, the drawing list generating unit is configured in such a manner as to generate the list indicating the polygon groups to become the drawing target for each set the node acquisition unit generates. Accordingly, it can carry out high speed drawing.

In addition, according to the image drawing device of the embodiment 1, the drawing unit is configured in such a manner as to refer to each row of the list the drawing list generating unit generates, issues the texture image designating command to a nonempty row only once, and issues a command to draw the individual polygon groups in the row. Accordingly, it can carry out high speed drawing.

Incidentally, it is to be understood that variations of any components of the embodiment or removal of any components of the embodiment is possible within the scope of the present invention.

### INDUSTRIAL APPLICABILITY

As described above, a drawing data generation device and an image drawing device in accordance with the present invention reduce the number of the texture images used at the drawing by making texture atlases by merging the texture images which are very likely to be drawn at the same time, and draw the polygon models corresponding to each texture atlas collectively. Accordingly, they are suitably applied to computer graphics and the like.

### DESCRIPTION OF REFERENCE SYMBOLS

1 preprocessing unit; 2 run-time processing unit; 3 HDD; 4 polygon drawing device; 11 node acquisition unit; 12 texture atlas generating unit; 21 drawing node determining unit; 22 drawing list generating unit; 23 drawing unit.

What is claimed is:

1. A drawing data generation device comprising:
a node acquisition unit that receives as its input, polygon groups which have a plurality of levels of detail represented in a tree structure and render a model at the plurality of levels of detail, and texture image groups properly assigned to the polygon groups, respectively, and that determines nodes corresponding to the texture image groups to be merged; and
a texture atlas generating unit that generates a texture atlas group by merging the texture image groups using information about the nodes the node acquisition unit generates, and that converts texture coordinates of vertices of the polygon groups while relating the texture coordinates to a drawing position.

2. The drawing data generation device according to claim 1, wherein
the node acquisition unit collects the nodes at a same depth in the tree structure in order beginning from a closer relative, and generates a node set which represents a set of the texture image groups capable of generating a texture atlas of a size closest to a maximum size a polygon drawing device that carries out polygon drawing can use.

3. An image drawing device comprising:
a node acquisition unit that receives as its input, polygon groups which have a plurality of levels of detail represented in a tree structure and render a model at the plurality of levels of detail, and texture image groups properly assigned to the polygon groups, respectively, and that determines nodes corresponding to the texture image groups to be merged;
a texture atlas generating unit that generates a texture atlas group by merging the texture image groups using information about the nodes the node acquisition unit generates, and that converts texture coordinates of vertices of the polygon groups while relating the texture coordinates to a drawing position;
a drawing node determining unit that uses the tree structure, polygon groups and texture atlas group the texture atlas generating unit outputs, and that determines drawing target polygon groups using at least information about a viewpoint position;
a drawing list generating unit that generates a list indicating drawing order of the drawing target polygon groups the drawing node determining unit determines; and
a drawing unit that issues to a polygon drawing device a command to draw the drawing target polygon groups using the list the drawing list generating unit generates.

4. The image drawing device according to claim 3, wherein
the drawing node determining unit determines the target nodes to be drawn in a manner not to select a same polygon group rendered at different levels of detail in accordance with a threshold set for each node of the tree structure and in accordance with positional relationships with a viewpoint.

5. The image drawing device according to claim 3, wherein
the drawing list generating unit generates the list that indicates the drawing target polygon groups for each set the node acquisition unit generates.

6. The image drawing device according to claim 3, wherein
the drawing unit refers to each row of the list the drawing list generating unit generates, issues a texture image designating command only once to a nonempty row, and issues a command to draw each polygon group in the row.
